(19) United States
(12) Patent Application Publication
(10) Pub. No.: US 2021/0366033 A1
(43) Pub. Date: Nov. 25, 2021

(54) INFORMATION PROCESSING APPARATUS, INFORMATION PROCESSING METHOD, AND COMPUTER PROGRAM

(71) Applicant: SONY CORPORATION, TOKYO (JP)

(72) Inventors: SHOHEI YAMAMOTO, TOKYO (JP); HIROTAKA SUZUKI, TOKYO (JP); KANAKO WATANABE, TOKYO (JP); HIROAKI OGAWA, TOKYO (JP); TOBIAS CINCAREK, TOKYO (JP); KAZUKI OCHIAI, TOKYO (JP); NORIKO TOTSUKA, TOKYO (JP)

(21) Appl. No.: 17/281,577

(22) PCT Filed: Oct. 3, 2019
(86) PCT No.: PCT/JP2019/039136

§ 371 Date: Mar. 30, 2021

(30) Foreign Application Priority Data
Oct. 12, 2018 (JP) 2018-193099

(51) Int. Cl. G06Q 30/06; G06F 3/01; G06Q 50/12; G06F 3/0488

(52) U.S. Cl. CPC G06Q 30/0643; G06Q 30/0631; G06F 3/0488; G06Q 50/12; G06F 3/011

(57) ABSTRACT

An information processing apparatus according to an embodiment includes a controller (100) performing control to display an interface receiving order contents relating to a dish from a user, control to reflect a change in order contents based on an operation performed by the user in real time on a dish image included in the interface, and control to transmit determined order contents to an external device.

### FIELD

The present invention relates to an information processing apparatus, an information processing method, and a computer program.

### BACKGROUND

Generally, when dishes are ordered in a restaurant or the like, the customers see the menu, determine the order, and tell the order to the employee. In recent years, systems in which the customers give orders by operating dedicated terminals set on the tables by themselves have been introduced.

In the order of dishes, various designations may be made, such as designation of quantity, such as large serving and small serving, the roasting degree, such as rare, medium, and well-done in steaks or the like, and seasoning, such as salty-sweet, medium-spicy, and extremely spicy, as well as the type (dish name) and/or the number of dishes. Patent Literature 1 described below discloses an input device capable of faithfully inputting various requests using a graph enabling input of information, such as the quantity, the roasting degree, and seasoning of dishes ordered by customers in a restaurant or the like in a stepless manner.

### CITATION LIST

### Patent Literature

Patent Literature 1: Japanese Patent Application Laid-open No. 2002-197553

### SUMMARY

### Technical Problem

However, detailed orders for dishes take time for oral communication and check, and input of numerical values thereof is difficult in operation of conventional dedicated terminals and causes a large burden on customers. In addition, the input device disclosed in Patent Literature 1 described above is capable of more faithfully designating the numerical value using a graph enabling stepless input, but does not enable the customer to recognize the actual size (quantity) or the like of the dish, and causes difficulty in customer's accurately designating the order desired by the customer only with the numerical value.

### Solution to Problem

For solving the problem described above, an information processing apparatus according to one aspect of the present disclosure has a controller performing: control to display an interface receiving order contents relating to a dish from a user; control to reflect a change in order contents based on an operation performed by the user in real time on a dish image included in the interface; and control to transmit determined order contents to an external device.

An information processing method according to one aspect of the present disclosure comprises causes a processor to: display an interface receiving order contents relating to a dish from a user; reflect a change in order contents based on an operation performed by the user in real time on a dish image included in the interface; and transmit determined order contents to an external device.

A computer program according to one aspect of the present disclosure causes a computer to function as a controller performing: control to display an interface receiving order contents relating to a dish from a user; control to reflect a change in order contents based on an operation performed by the user in real time on a dish image included in the interface; and control to transmit determined order contents to an external device.

### BRIEF DESCRIPTION OF DRAWINGS

FIG. 1 is a diagram explaining an outline of a cooking system according to an embodiment of the present disclosure.

FIG. 2 is a block diagram illustrating an example of a whole configuration of the cooking system according to the present embodiment.

FIG. 3 is a flowchart illustrating an example of flow of operation processing when an order is placed in the cooking system according to the present embodiment.

FIG. 4 is a diagram illustrating an example of menu selection display according to the present embodiment.

FIG. 5 is a diagram explaining a change in the size of a dish by an intuitive operation input for a dish image according to the present embodiment.

FIG. 6 is a diagram explaining a stepped change of a plate in a change in the size of the dish according to the present embodiment.

FIG. 7 is a diagram explaining recommendation according to the number of people in a change in the number of pieces in the dish according to the present embodiment.

FIG. 8 is a diagram explaining an operation of changing a seasoning and the like of the dish according to the present embodiment.

FIG. 9 is a diagram explaining display of detailed information on the dish according to the present embodiment.

FIG. 10 is a diagram illustrating an example of an individual serving designation operation according to the present embodiment.

FIG. 11 is a diagram illustrating another example of the individual serving designation operation according to the present embodiment.

FIG. 12 is a diagram illustrating an example of user interface to perform an operation of designating a serving timing according to the present embodiment.

FIG. 13 is a diagram illustrating an example of the case of displaying cooking progress information on the table according to the present embodiment.

### DESCRIPTION OF EMBODIMENTS

A preferred embodiment of the present disclosure will now be described in detail hereinafter with reference to attached drawings. In the present specification and drawings, constituent elements having substantially the same function and structure will be denoted by the same reference numerals, and an overlapping explanation thereof is omitted.

In addition, the explanation will be made in the following order.

1. Outline of cooking system according to an embodiment of the present disclosure

2. Configuration example

3. Operation processing

4. Example of operation of changing contents of order
4-1. Operation of changing size (quantity)
4-2. Operation of changing serving order of dishes
4-3. Operation of designating position of placing dishes
4-4. Change operation after ordering

5. Modifications
5-1. Sound input
5-2. Modification of display output
5-3. Others

6. Conclusion

### 1. OUTLINE OF COOKING SYSTEM ACCORDING TO AN EMBODIMENT OF THE PRESENT DISCLOSURE

A cooking system according to an embodiment of the present disclosure is supposed to be used in facilities, such as a restaurant and an airport lounge, and home equipped with a cooking robot (automatic cooking apparatus 40) and the like. The cooking system is also supposed to be used in the case where a cooking robot (automatic cooking apparatus 40) is installed in facilities, such as a restaurant and an airport lounge.

Background

As described above, detailed orders for dishes take time for oral communication and check, and input of numerical values thereof is difficult in operation of conventional dedicated terminals and causes a large burden on customers. In addition, the input device disclosed in Patent Literature 1 described above is capable of more faithfully designating the numerical value using a graph enabling stepless input, but does not enable the customer to recognize the actual size (quantity) or the like of the dish, and causes difficulty in customer's accurately designating the order desired by the customer only with the numerical value.

For this reason, the present disclosure enables the user (customer) to intuitively placing a detailed order for dishes and enables input of order faithful to the user's demand, by displaying a dish image reflecting the user's demand on the table together with additional information (such as the nutritive values, calories, quantity, time required for serving, and value) and updating the dish image and/or the additional information in real time in accordance with the user's intuitive operation (such as pinch-in and pinch-out operation by a touch operation, operation of the slide bar, and sound input).

In addition, the cooking system according to an embodiment of the present disclosure solves a gap between the dish image assumed by the user at the time of ordering and the actually served dish by displaying a dish image displayed on the table in an actually served state (that is, actual size).

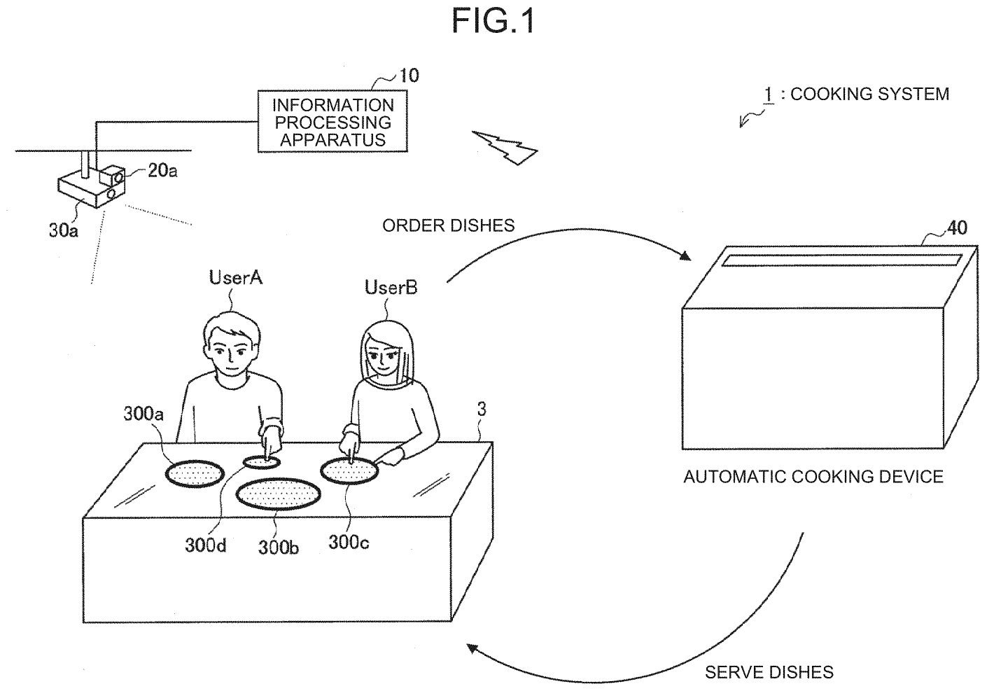

FIG. 1 is a diagram explaining an outline of a cooking system 1 according to an embodiment of the present disclosure. As illustrated in FIG. 1, the cooking system 1 according to the present embodiment displays dish images 300 (300a to 300d) on a table 3, updates the dish images 300 in real time in accordance with a user's intuitive operation for the dish images, and receives an order input by the user. For example, the cooking system 1 changes the size of the dish image displayed in the actual size in accordance with a pinch-in or a pinch-out operation, and acquires the size of the dish ordered by the user in accordance with the changed size of the dish image. In addition, the present embodiment enables designation of the number of pieces in the dish, seasoning of the dish, a serving state, such as individual serving, and the serving order and the like, as well as the dish name and the size (quantity) of the dish, by an intuitive operation for the dish image displayed in the actual size.

Display of the dish images 300 on the table 3 is performed with an output device 30. The output device 30 may be a projector 30a (such as a moving projector) projecting an image on the tabletop, or a display provided on the top plate of the table 3. The output device 30 displays the dish images 300 on the table 3 in accordance with control of an information processing apparatus 10. A plurality of output devices 30 may be provided.

An operation by the user for the disk images 300 is detected with an input device 20. The input device 20 is a sensor device sensing various pieces of information. The input device 20 includes, for example, a camera and a microphone and the like, and outputs the sensed information to the information processing apparatus 10. A plurality of input devices 20 may be provided.

The information processing apparatus 10 determines an order on the basis of the user's operation detected with the input device 20 and a display state of the table 3 displayed with the output device 30, and outputs the order to the cooking side. The output destination of the order may be an automatic cooking device 40, such as a cooking robot, or may be an order display device installed in a kitchen or a printer printing and outputting the order when cooking is performed by manpower.

As described above, the cooking system 1 according to the present disclosure enables easy and intuitive execution of an order of dishes by a direct operation for dish images displayed on the table 3.

The ordered dishes are carried to the table 3 by manpower and/or a serving robot or the like.

The outline of the learning support system according to the embodiment of the present disclosure has been explained above. The following is a specific explanation of each of the devices forming the cooking system 1 according to the present embodiment.

### 2. CONFIGURATION EXAMPLE

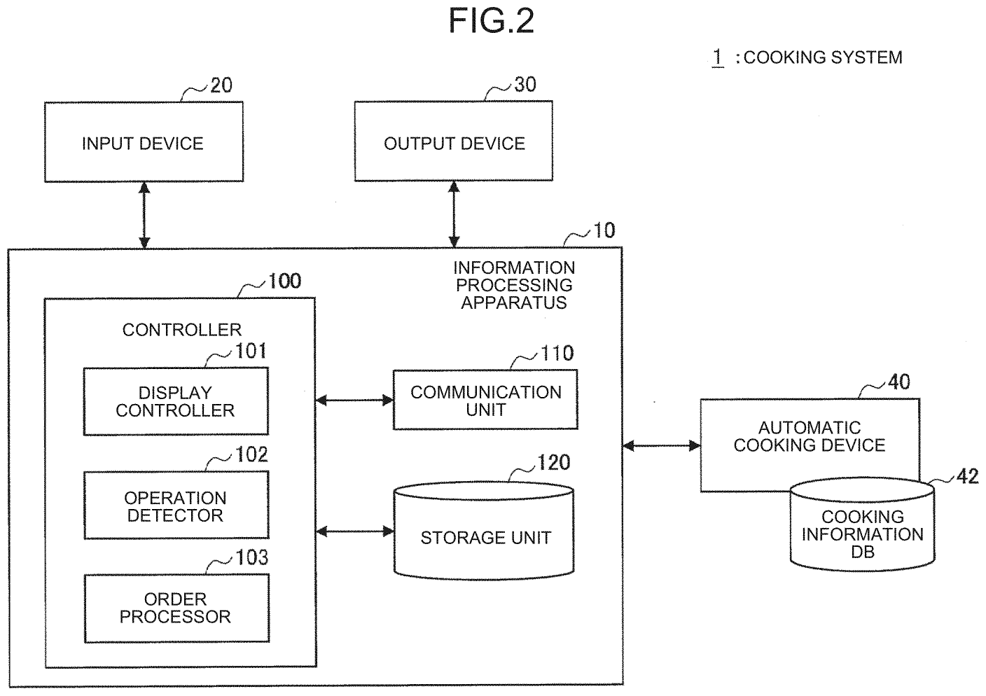

FIG. 2 is a block diagram illustrating an example of a whole configuration of the cooking system 1 according to the present embodiment.

2-1. Input Device 20

The input device 20 includes, for example, a camera 20a, a depth sensor, and a microphone and the like.

The camera 20a is an imaging device, such as a RGB camera, including a lens system, a drive system, and an imaging element, and imaging an image (still image or moving image). The depth sensor is a device acquiring depth information, such as an infrared ranging device, an ultrasonic ranging device, a laser imaging detection and ranging (LiDAR), or a stereo camera. The microphone is a device collecting ambient sound and outputting sound data obtained by converting the ambient sound into a digital signal via an amplifier and an analog digital converter (ADC).

The input device 20 senses information on the basis of control by the information processing apparatus 10. For example, the information processing apparatus 10 is capable of controlling the zoom ratio and the imaging direction of the camera 20a.

The input device 20 may include constituent elements capable of performing desired sensing other than the constituent elements described above. For example, the input device 20 may include a device to which information is input by the user, such as a mouse, a keyboard, a touch panel, a button, a microphone, a switch, and a lever. The input device 20 may also include various sensors, such as an acceleration sensor, a gyro sensor, a geomagnetic sensor, an optical sensor, an illuminance sensor, and a force sensor.

2-2. Output Device 30

The output device 30 includes a display device, such as the projector 30a and a tabletop display, and a speaker (sound output device). The cooking system 1 may include one of them or a combination of them, as the output device 30, or a plurality of devices of the same type.

The projector 30a is a projection device projecting an image on a desired place in the space. The projector 30a may be, for example, a wide-angle projector of a fixed type, or a moving projector including a movable unit capable of changing the projection direction, such as a Pan/Tilt drive type. The projector 30a projects an image on the table 3 and/or the ambient wall on the basis of control of the information processing apparatus 10.

The tabletop display is a display provided on the top plate of the table 3 onto which dishes are served, and capable of outputting an image and sound and the like. The tabletop display may be provided in the whole area of the table 3, or part of the area of the table 3. The output device 30 may include a wall display set on the wall surrounding the table 3.

The speaker converts sound data into an analog signal via a digital analog converter (DAC) and an amplifier and outputs (plays back) the sound. The output device 30 may include a unidirectional speaker capable of forming directivity in a single direction.

The output device 30 outputs information on the basis of control by the information processing apparatus 10. The information processing apparatus 10 is capable of also controlling the output method in addition to contents of the output information. For example, the information processing apparatus 10 is capable of controlling the projection direction of the projector 30a.

The output device 30 may include constituent elements capable of performing desired output other than the constituent elements described above. For example, the output device 30 may include a wearable device, such as a head mounted display (HMD), augmented reality (AR) glasses, and a wristwatch-type device.

2-3. Information Processing Apparatus 10

The information processing apparatus 10 includes a controller 100, a communication unit 110, and a storage unit 120.

Controller 100

The controller 100 functions as an arithmetic processing unit and a control device, and controls general operations in the information processing apparatus 10 in accordance with various computer programs. The controller 100 is achieved with an electronic circuit, such as a central processing unit (CPU) and a microprocessor. The controller 100 may include a read only memory (ROM) storing therein computer programs and arithmetic parameters to be used, and/or a random access memory (RAM) temporarily storing therein properly changing parameters and the like.

The controller 100 according to the present embodiment also functions as a display controller 101, an operation detector 102, and an order processor 103.

The display controller 101 controls the output device 30 to display dish images and/or additional information and the like on the table 3. The display controller 101 also performs control to update the dish images and/or the additional information in real time in accordance with a user's operation detected with the operation detector 102.

In addition, the display controller 101 is capable of generating dish images and/or additional information to be displayed, on the basis of image information registered on the storage unit 120 in advance and information (recipe information (information relating to the ingredients to be used, the cooking time, and the cooking method), ingredient residual quantity information (ingredient stock state), cooking situation (order congestion in the kitchen), and captured images of the cooked dishes) relating to cooking acquired from cooking information database (DB) 42 of the automatic cooking device 40.

The operation detector 102 has a function of detecting user operation information on the basis of the information sensed with the input device 20. The user operation information can be detected with, for example, the depth camera, a thermo camera, a RGB camera, an ultrasonic sensor, and/or a microphone of the input device 20. The user operation information is a touch operation of the user on the table 3, such as a touch, a tap, a double-tap, and a swipe, or information, such as sound.

As a touch operation, for example, an operation input for the dish images 300 projected on the table 3 is detected. The operation detector 102 analyzes the image acquired from the camera 20a and/or the depth information when the dish images 300 are projected on the table 3 with the projector 30a, acquires the position of the user's hand and/or fingers positioned on the display surface and the depth information thereof (in other words, three-dimensional information), and detects contact or approach of the user's hand with or to the table 3 in the height direction and separation of the hand from the table 3. In the present specification, contact or approach of the user's operation part, such as the hand and the finger, with or to the display screen is also simply referred to as “contact”.

The order processor 103 has a function of determining the order (specifically, for example, the dish name, the size (quantity) of the dish, the number, the seasoning, the serving state, such as individual serving, and/or serving order of the dishes) on the basis of the user operation detected with the operation detector 102, and transmitting the order to the automatic cooking device 40.

Communication Unit 110

The communication unit 110 is a communication module to perform transmission and reception of data to and from another device in a wired/wireless manner. The communication unit 110 communicates with an external device directly or in a wireless manner via a network access point by a method, such as a wired local area network (LAN), a wireless LAN, wireless fidelity (Wi-Fi, registered trademark), infrared communication, Bluetooth (registered trademark), short-range/non-contact communication, and a portable communication network (long term evolution (LTE) and 3G (third-generation mobile communication system)).

For example, the communication unit 110 is capable of transmitting and receiving data to and from the input device 20, the output device 30, and the automatic cooking device 40.

Storage Unit 120

The storage unit 120 is achieved with a read only memory (ROM) storing therein computer programs and/or arithmetic parameters used for processing performed with the controller 100 described above and a random access memory (RAM) temporarily storing therein properly changing parameters.

For example, the storage unit 120 may store therein various pieces of sensor information acquired with the input device 20, user operation information detected with the operation detector 102, and cooking information acquired from the cooking information DB 42 and/or cooking information registered in advance and the like.

The configuration of the information processing apparatus 10 according to the present embodiment has been specifically explained above. The configuration explained above with reference to FIG. 2 is a mere example, and the functions and the configuration of the information processing apparatus 10 according to the present embodiment are not limited to the example described above.

2-4. Automatic Cooking Device 40

The automatic cooking device 40 has a function of controlling a cooking robot and the like and performing cooking in accordance with the order transmitted from the information processing apparatus 10. In the present embodiment, a specific structure of the automatic cooking device 40 is not specifically limited.

The automatic cooking device 40 according to the present embodiment includes the cooking information DB (database) 42 storing therein ingredient stock information and the like. The cooking information DB 42 stores therein recipe information (information relating to the ingredients used for cooking, the quantity (volume) of a portion for one person, the size, the calories, the nutritive values, the time required for cooking, and the cooking method (including process)), price information, ingredient stock information, the cooking situation (such as the order congestion in the kitchen and the waiting order), the serving state (such as an image of the tableware to be used), and captured images of cooked dishes, as information relating to cooking (cooking information), and the information is continuously/regularly updated. In addition, the cooking information stored in the cooking information DB 42 is properly provided to the information processing apparatus 10. The ingredient stock information is acquired on the basis of an image of the inside of the refrigerator, an image of the inside of the shelf in which the foods and/or seasonings are stored, or information input by the user or the like, for example, when the present system is used at home. Providing the ingredient stock information enables the information processing apparatus 10 to determine whether the order is an acceptable order. The captured image of the cooked dish is a captured image of the dish cooked on the basis of the order, and can be stored in association with the contents of the order. The information processing apparatus 10 is capable of properly generating dish images 300 to be displayed on the table 3 at the time of ordering on the basis of captured images of the dishes.

The cooking information DB 42 may also store therein the order history (eating history) of each of users. By providing the user's eating history, the information processing apparatus 10 is enabled to issue proper advice and/or warning on the basis of the user's health state, the latest caloric intake, and/or the nutritive balance, when the user newly places an order.

Even when cooking is performed by manpower, a cooking-side device (such as a personal computer and a tablet terminal) including the cooking information DB 42 storing therein ingredient stock information and/or recipe information and the like may be introduced to provide cooking information to the information processing apparatus 10 in real time.

3. Operation Processing

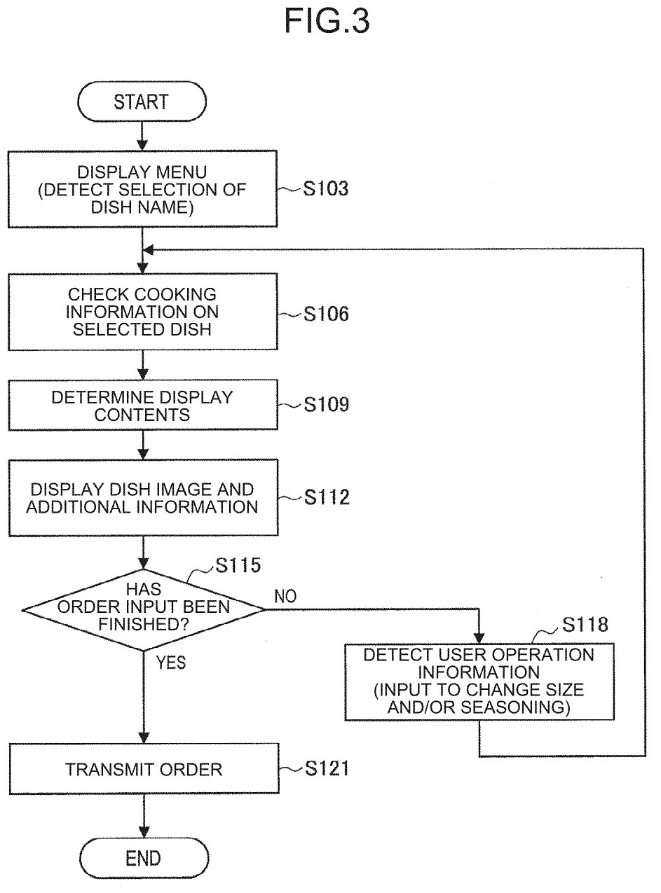

The following is a specific explanation of operation processing at the time of ordering in the cooking system 1 according to the present embodiment with reference to FIG. 3. FIG. 3 is a flowchart illustrating an example of flow of operation processing when an order is placed in the cooking system 1 according to the present embodiment.

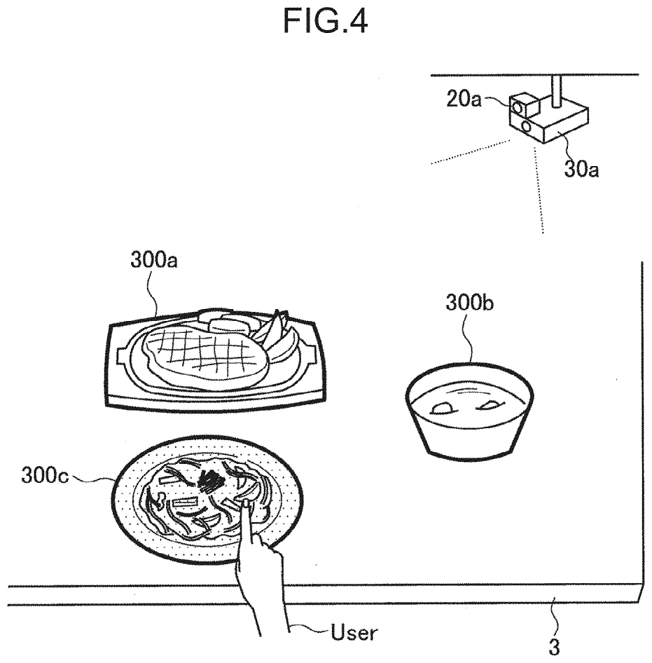

As illustrated in FIG. 3, first, the controller 100 of the information processing apparatus 10 displays a menu (menu selection screen) on the table 3, and detects a user's operation of selecting the dish name (Step S103). FIG. 4 illustrates an example of menu selection display according to the present embodiment. As illustrated in FIG. 4, in the present embodiment, for example, the projector 30a projects selectable dish images 300a to 300c on the table 3. The dish images 300a to 300c may be displayed in the actual size, or displayed in a reduced size at the stage of menu display. Actual size information on the dish images 300a to 300c is acquired from, for example, the cooking information DB 42. The user taps the dish image 300c to be ordered.

Thereafter, the controller 100 of the information processing apparatus 10 checks the cooking information on the selected dish (Step S106), and determines the display contents (Step S106). Specifically, for example, the controller 100 checks the ingredient stock of the dish selected by the user on the basis of the latest cooking information acquired from the cooking information DB 42, and determines whether the dish is currently in a servable state. The controller 100 also checks the recipe information to acquire (calculate) the calories and/or the nutritive values of the disk selected by the user and acquire the value information and/or the serving time (time required for serving) thereof. The serving time may be calculated more accurately in view of the current order congestion state (order waiting state or the like) in the kitchen included in the latest cooking information. On the basis of these checks, the controller 100 determines the display contents, that is, generates the dish image and the additional information. A captured image of the already registered cooked dish may be used as the dish image, or the dish image may be generated by computer graphics (CG). The controller 100 performs control to display the dish image in the actual size on the table 3 on the basis of the size information included in the dish information. The controller 100 also generates additional information on the dish selected by the user, such as the price, the serving time, the calories, and the nutritive values, on the basis of the cooking information.

Thereafter, the display controller 101 controls the projector 30a to display the dish image and the additional information on the table 3 (Step S112).

Thereafter, until the order input by the user is finished (No at Step S115), user operation information is detected (Step S118) from the sensing information continuously acquired with the input device 20. Finish of the order input is explicitly instructed by the user by, for example, a tap of the “order” button displayed on the table 3, a certain gesture, or sound. Before the user finishes the order input, the user is enabled to perform an intuitive operation input on the dish image 300 displayed on the table 3 and change the detailed order contents, such as the size and/or the seasoning of the ordered dish.

When an operation input to change the order contents is performed, the controller 100 checks the cooking information again (Step S106), determines the display contents (Step S109), and displays the dish image and the additional information reflecting the change on the table 3 (Step S112). A change in the order contents by an intuitive operation input for the dish image 300 will be described later with reference to drawings.

Thereafter, when the order input is finished (Yes at Step S115), the order processor 103 of the information processing apparatus 10 transmits the order to the automatic cooking device 40 (Step S121).

An example of the operation processing according to the present embodiment has been explained above. The operation processing illustrated in FIG. 3 is a mere example, and the present disclosure is not limited to the example illustrated in FIG. 3. For example, the present disclosure is not limited to the order of steps illustrated in FIG. 3. At least some of the steps may be processed in parallel, or processed in reverse order. As another example, all the processing steps illustrated in FIG. 3 are not necessarily executed. All the processing steps illustrated in FIG. 3 are not required to be executed with the same single device.

### 4. EXAMPLE OF OPERATION OF CHANGING CONTENTS OF ORDER

The following is a specific explanation of a change in the contents of the order by intuitive operation input for the dish image 300 according to the present embodiment with reference to drawings.

4-1. Operation of Changing Size (Quantity)

Pinch-in/Pinch-Out Operation

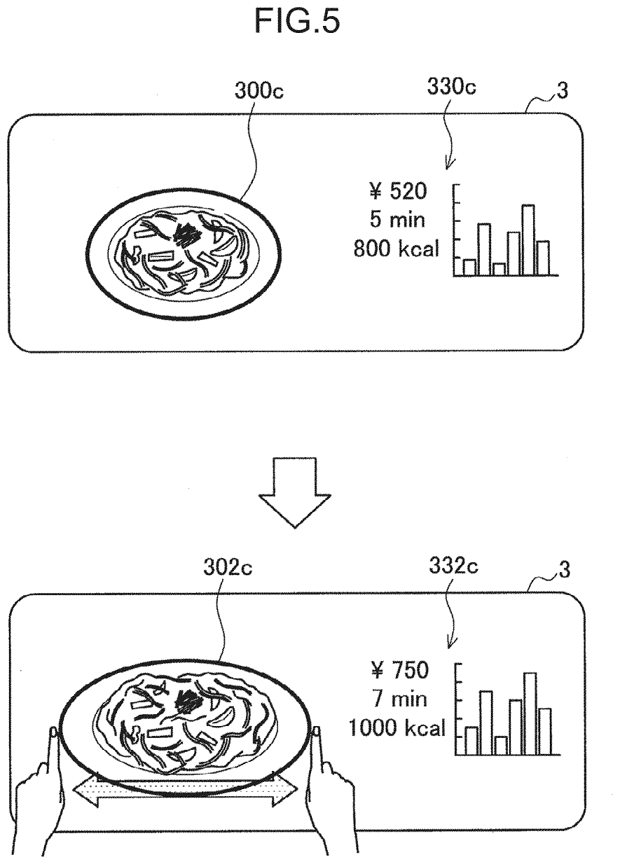

A change in the size of the dish by intuitive operation input for the dish image 300 will be explained hereinafter with reference to FIG. 5. As illustrated in the upper part of FIG. 5, for example, when the dish image 300c in the actual size and additional information 330c, such as the price and the calories, are projected on the table 3, in the case where the user wishes to increase (increase the quantity) the size of the dish, the user performs a pinch-out operation on the dish image 300c. The pinch-out operation by the user on the table 3 is sensed with the depth sensor of the input device 20, an image sensor, or the touch sensor provided on the table 3 or the like.

Thereafter, as illustrated in the lower part of FIG. 5, when the information processing apparatus 10 detects the pinch-out operation performed by the user, the information processing apparatus 10 displays a dish image 302c in an increased size (increased quantity) in accordance with the pinch-out operation of the user. The information processing apparatus 10 also reflects the price and the calories changed in accordance with increase in quantity on additional information 332c.

FIG. 5 illustrates the example in which a pinch-out operation is performed on the dish image 300c in the case where the user wishes to increase the size (increase the quantity) of the dish, but the present embodiment is not limited thereto. When the user wishes to reduce the size (reduce the quantity) of the dish, the user is enabled to change the size in the same manner, by performing a pinch-in operation on the dish image 300c.

With the structure described above, the user is enabled to recognize the size of the dish to be actually served, and properly and intuitively adjust the size (quantity) of the dish to be ordered.

When the size of the dish is changed by a pinch-in and/or pinch-out operation, as long as the quantity of the dish can be adjusted in a stepless manner, such as noodles, soup, and the size of meat, the size of the dish image 300 can be adjusted (increased or reduced) in a stepless manner in accordance with a user's operation (distance between the two fingers). By contrast, the size of the plate used for serving is supposed to be limited to a certain degree. To display a dish image more faithful to the actual state, the information processing apparatus 10 can perform control to also display the size of the plate used for actual serving in the actual size. The plate size information can be acquired from the cooking information DB 42.

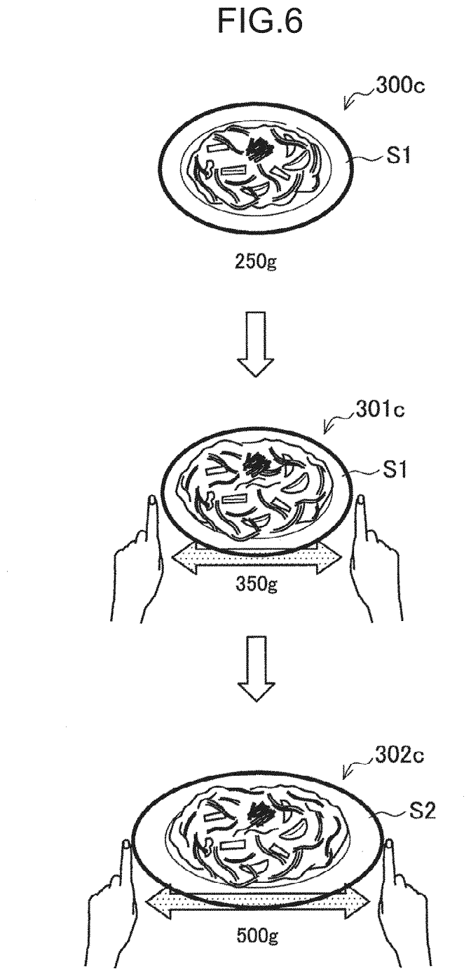

FIG. 6 is a diagram explaining a stepped change of a plate in a change in the size of the dish according to the present embodiment. The upper part of FIG. 6 illustrates dish image 300c of normal serving. A plate s1 included in the dish image 300c is actual size display of the plate used when the dish is actually served. Thereafter, when the user performs a pinch-out operation on the dish image 300c, the information processing apparatus 10 is capable of gradually (steplessly) increasing the quantity of the dish placed on the plate s1 to the quantity of a dish image 301c of medium-sized portion illustrated in the middle part of FIG. 6. In this operation, an image in which the quantity of the dish placed on the plate s1 gradually increases is displayed, also the size of the plate s1 is not changed. When the quantity exceeds a certain value, the plate s1 is changed to a plate s2 having a size larger than that of the plate s1 by one level as illustrated in the lower part of FIG. 6, and the quantity of the dish continues to gradually increase.

As described above, the dish image faithful to the actual state is displayed, including the serving state, such as the actually used plate. This structure solves a gap between the dish supposed by the user at the time of ordering and the actually served dish. This structure also enables the user to grasp in advance whether all the ordered dishes can be placed on the table 3, and avoid a narrowed space on the table due to the order of an excessive number of dishes.

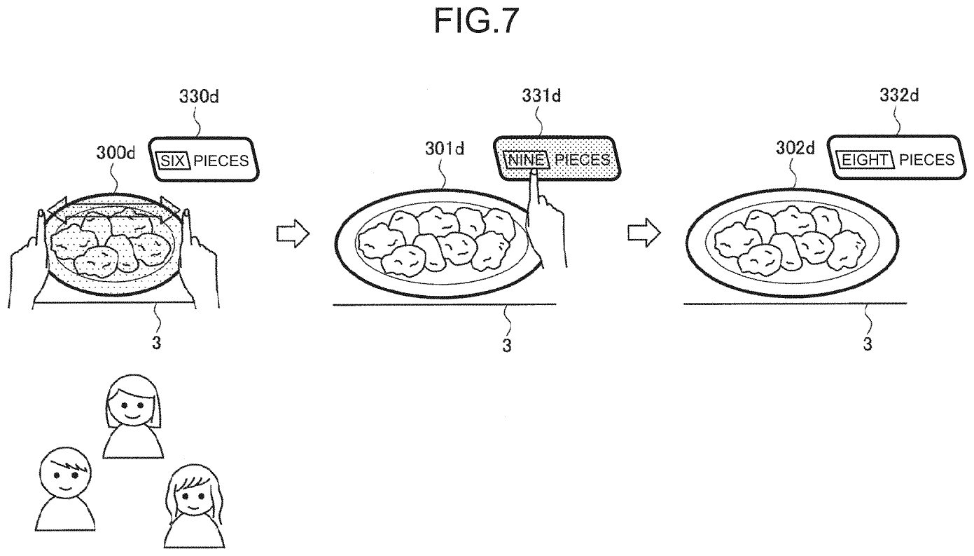

In addition, in some dishes, the quantity of the dish does not increases/decreases steplessly, but the number of pieces in the dish changes. In this case, the information processing apparatus 10 performs display control to increase/decrease the number of pieces in the dish to be displayed in real time, in accordance with a user's pinch-in/pinch-out operation for the dish image 300. In addition, when the number of users in a group is recognized, the information processing apparatus 10 is capable of recommending increase/decrease in the number of pieces to a number being a multiple of the number of users in a group. For example, when the customer in a group formed of three users pinches out the dish image 300, the information processing apparatus 10 may increase the number of pieces in the dish to six pieces, nine pieces, twelve pieces, . . . . After the recommendation, the user may revise the number of pieces by touching a pop-up displayed in the vicinity of the dish image 300. For example, in the case where the number of users in a group is three as illustrated in FIG. 7, when the quantity of the dish image 300d being a dish including six pieces in normal serving is increased by a pinch-out operation, the information processing apparatus 10 displays a dish image 301d including nine pieces being a multiple of the number of users in a group. As described above, in increase/decrease in quantity of the dish, the structure enables recommendation of increase/decrease to pieces of a number being a multiple of the number of users in the group. When the user wishes to change the number of pieces to be ordered, the user taps a piece number display 331d displayed in the vicinity of the dish image 300d to change the number of pieces to a desired number of pieces (for example, eight). When the number of pieces is changed, the information processing apparatus 10 reflects the change in the number of pieces on the dish image 302d in real time. In addition, when the default number of pieces in the dish is not a multiple of the number of users in the group, the information processing apparatus 10 is also capable of automatically adjusting the quantity to pieces of a number being a multiple of the number of users in the group and displaying the adjusted number of pieces. For example, when a group including three users orders a dish including five skewered grills, the information processing apparatus 10 automatically changes the number of pieces to six, and displays the dish image 300 reflecting the change.

The method of changing the size (quantity) of the dish by a pinch-in/pinch-out operation as an intuitive operation for the dish image has been explained above, but the present embodiment is not limited thereto. The changing operation may be another operation (including a gesture). As another example, the method may be a method of changing the size (quantity) of the dish by an operation of a slide bar displayed on the table 3.

Operation of Changing Seasoning and the Like

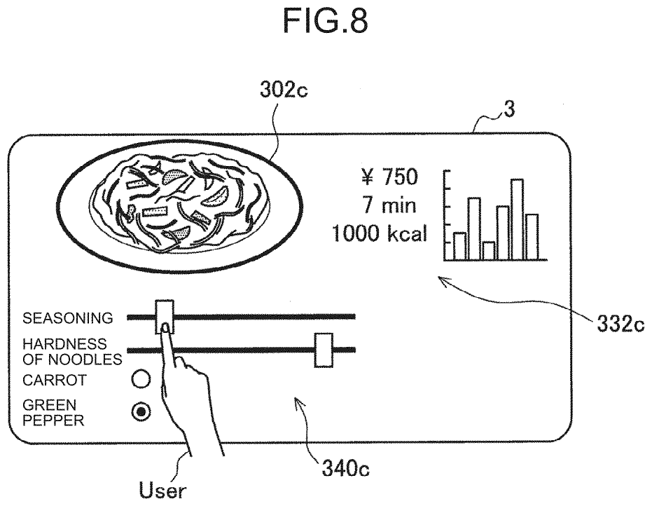

The following is an explanation of a changing operation, such as seasoning of the dish, with reference to FIG. 8. As illustrated in FIG. 8, for example, it is possible to perform stepless or stepped adjustment of seasoning (such as strong and light) of the dish, whether to use a specific ingredient, and the cooking degree (such as roasting degree, boiling degree, and hardness of noodles) with a slide bar and/or a radio button (adjustment display 340c). The information processing apparatus 10 changes the display contents of the dish image 302c and/or the additional information 332c in real time in accordance with an intuitive user operation (operation of the slide bar and/or the radio button) for the adjustment display 340c. Specifically, the information processing apparatus 10 calculates and changes information, such as the calories, the price, the nutritive values, and the serving time displayed as the additional information 332c, in real time (or using numerical values calculated in advance) in accordance with a change in order contents by an operation of the adjustment display 340c. In addition, because the appearance of the dish image 302c may change according to the presence/absence of the ingredient to be used and the seasoning, the information processing apparatus 10 changes the dish image 302c in real time to be faithful to the actual state. Change of the dish image 302c may be generated by processing the captured image of the cooked dish acquired in advance. Corresponding order information is added to the captured image of the cooked dish, and the information processing apparatus 10 is capable of properly processing the captured image on the basis of the order contents changed with the adjustment display 340c, and displaying the processed image as the dish image 302c.

Display of Detailed Information on Dish

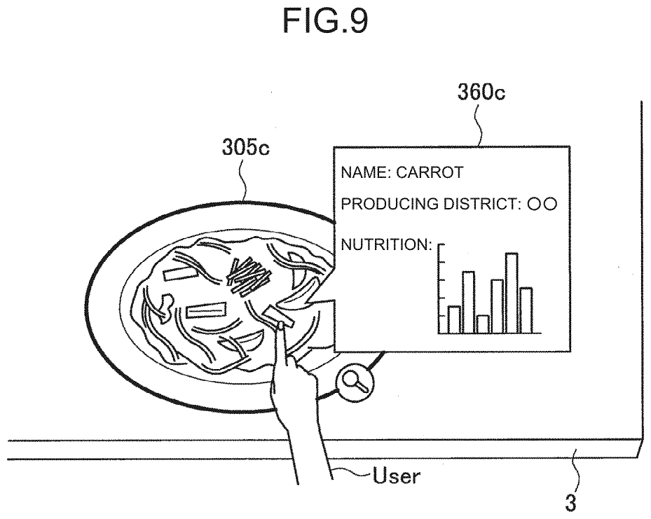

The information processing apparatus 10 is also capable of displaying the dish image 300 in an enlarged/reduced state, in accordance with a user's intuitive operation input for the dish image 300. For example, the user is enabled to enlarge the dish image 300 in display to check the ingredients included in the dish by visual observation. In addition, when the user cannot recognize what ingredient is included in the dish even by visual observation, the user is enabled to cause the information processing apparatus 10 to display detailed information in a pop-up manner by tapping the ingredient in the image. FIG. 9 is a diagram explaining display of detailed information on the dish according to the present embodiment. As illustrated in FIG. 9, when a specific ingredient in a dish image 305c displayed in an enlarged state is tapped, display 360c of detailed information on the ingredient is displayed as a pop-up window. The detailed information on the ingredient includes, for example, the name, the quality, the producing district, and the nutritive values and the like. An enlargement operation for the dish image 305c may be, for example, a pinch-out operation with two fingers, to distinguish it from the size change operation described above, while the size change operation is a pinch-out operation with one finger. As another example, enlargement display may be performed by tapping an enlargement button. An icon (such as a magnifying glass illustrated in FIG. 9) indicating that the image is an enlarged image may be displayed in the dish image 305c serving as enlarged display.

Designation of Individual Serving Method

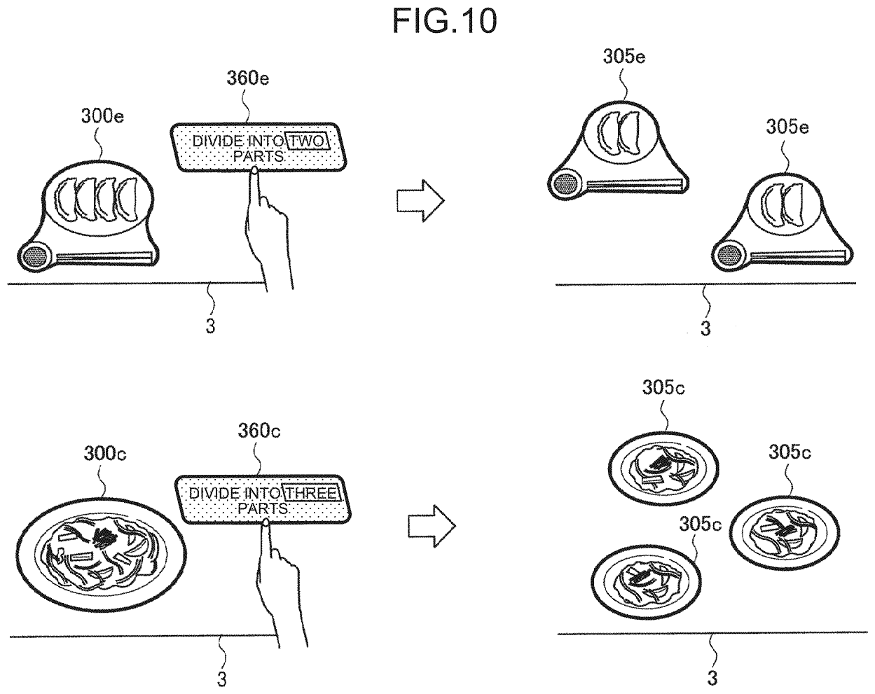

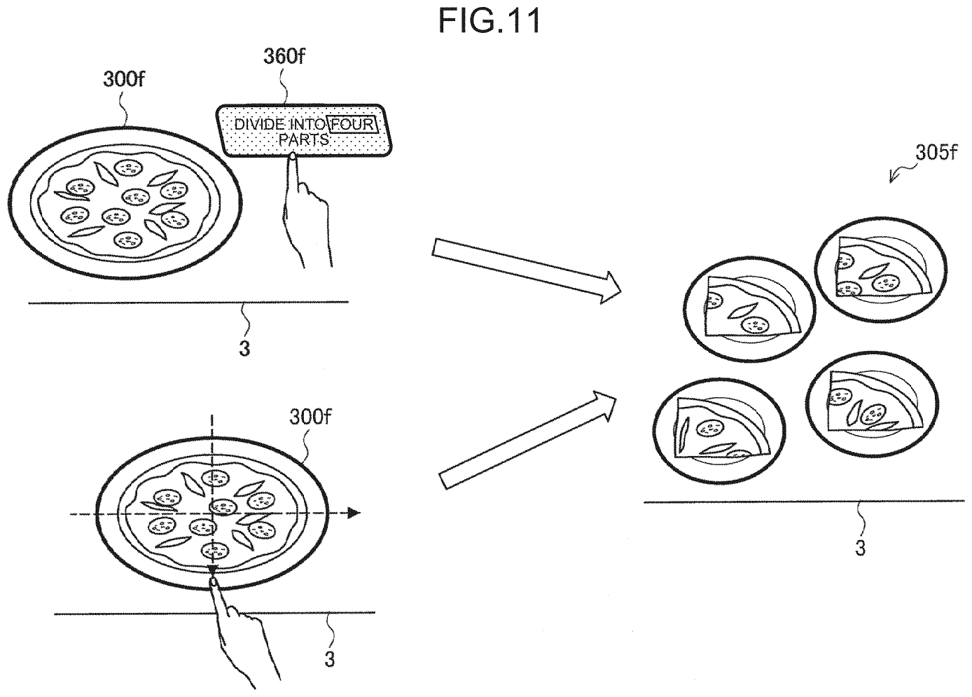

When a dish is ordered for a plurality of users, an individual serving method may be designated in the order. The individual serving method may be designated in various ways, such as a method of distributing the dish by quantity, the method of distributing the dish by the number of pieces, and a method of cutting the dish into pieces. Specific examples of the individual serving method will be explained hereinafter with reference to FIG. 10 and FIG. 11.

FIG. 10 is a diagram illustrating an example of an individual serving designation operation according to the present embodiment. As illustrated in FIG. 10, for example, in the case of ordering a dish for which individual serving designation is possible, the information processing apparatus 10 displays a “divide into X” button 360 on one side of the dish image 300. In the “divide into X parts” button 360, the number of users grasped with the system may be displayed in advance. The number of users may be grasped with the camera 20a and the like. As another example, the user may change the number of parts of equal dividing in the “divide into X parts” 360 button by, for example, a pull-down method.

When the “divide into X parts” button 360 is tapped, the information processing apparatus 10 displays the equally divided dish image 305. The equally divided dish image 305 is an image of the state in which the dish is actually divided into equal parts in serving, and displayed in the actual size. The information processing apparatus 10 may generate the equally divided dish image 305 on the basis of a captured image of the actually equally divided dish acquired from the cooking information DB 42.

FIG. 11 is a diagram illustrating another example of the individual serving designation operation according to the present embodiment. In the case of ordering a dish equally divided by cutting, such as a pizza and a whole cake, a method of automatically equally dividing the dish into parts equal to the number of users in the group may be designated as illustrated in the upper part of FIG. 11, or a method of designating desired cutting by the user with a finger as illustrated in the lower part of FIG. 11.

The information processing apparatus 10 may display additional information (such as calories and nutritive values) for each of the equally divided parts of the dish. In the case where the quantity, the seasoning, and/or the topping and the like can be changed for each of the equally divided parts of the dish, the information processing apparatus 10 may display an operation screen, such as a slide bar for change, or receive a user's operation for the equally divided dish image.

The individual serving is not limited to “equal dividing”, but the ratio of the divided quantities may be changed automatically or as desired, such as the quantity ratio of adult to child. As another example, when the quantity of one part of the equally divided dish is reduced, the quantity of the other part of the equally divided dish may be automatically increased.

In any cases, the individual serving state and/or the details of change are reflected in real time on the dish image in the actual size indicating the actual serving state. This structure enables the user to visually and intuitively check the ordered dish.

As described above, designating the individual serving state and checking the state after individual serving solve a gap between the dish image assumed by the user at the time of ordering and the actually served dish.

4-2. Operation of Changing Serving Order of Dishes

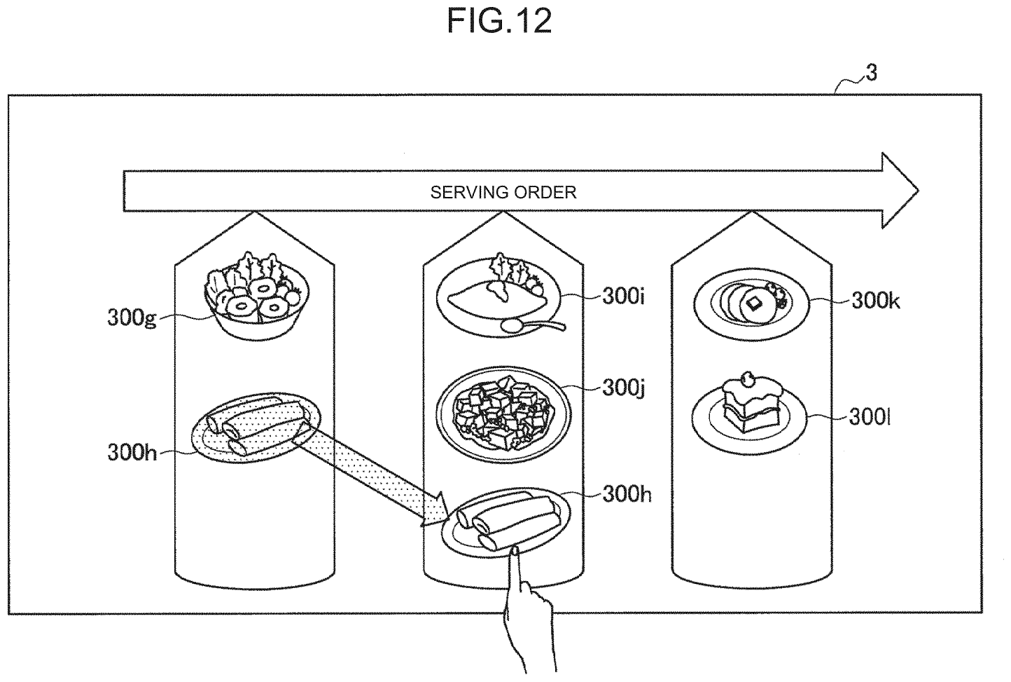

In the present embodiment, the timing of serving each of the dishes may be designated at the time of ordering. FIG. 12 is a diagram illustrating an example of user interface (UI) to perform an operation of designating the serving timing according to the present embodiment. a button to display the UI to perform an operation of designating the serving timing may be always displayed on the table 3.

As illustrated in FIG. 12, the UI to perform an operation of designating the serving timing may be a UI to designate the serving order by, for example, arranging the dish images 300 (not necessarily displayed in the actual size herein) along a timeline. When the user wishes serving of dishes at the same timing, the user should arrange the dish images 300 in a direction perpendicular to the timeline. As default settings, the serving timings may be set on the basis of fixed rules (for example, appetizers are served first, main dishes are served thereafter, and desserts are served lastly). When the user wishes to change the serving timing of the dish image 300h set to be served first in default settings to the same serving timing as those of the dish images 300i and 300j to be served next, the user moves the dish image 300h to a space under the dish images 300i and 300j by a touch operation, as illustrated in FIG. 12.

The information processing apparatus 10 includes information on the designated serving order of the dishes in the order, and notifies the automatic cooking device 40 of the order.

4-3. Operation of Designating Position of Placing Dishes

In the present embodiment, the ordered dish image 300 may be always displayed on the table 3, and the dish may be served in the display position of the dish image 300 at the time of serving. The user is enabled to move the display position of the dish image 300 by sliding the dish image 300 as desired by a touch operation or the like to designate the serving position to a desired position.

When the information processing apparatus 10 senses that the dish is served, the information processing apparatus 10 may change the corresponding dish image 300 to a non-displayed state.

This structure enables the user to grasp and change the serving position of the ordered dish in advance. In addition, when all the dishes can be placed on the table 3 or the space on the table 3 is narrowed with the served dishes, this structure enables adjustment of the eating pace by individually serving the dishes early to individual small plates to clear away the large plate.

In addition, the information processing apparatus 10 may display the dish image 300 on the table 3 in accordance with the set serving timing. Specifically, the structure is not limited to the structure in which all the dish images of the ordered dishes are displayed simultaneously, but the dish image 300 of the dish to be served next may be displayed in advance.

In addition, when no serving space is left on the table 3 (specifically, when no space is left to display the dish image 300 of the dish to be served next), the information processing apparatus 10 is also capable of notifying the automatic cooking device 40 to wait for the serving timing.

In the present system, when the customers are a group of a plurality of users, the information processing apparatus 10 may store therein who has ordered which dish, and notify the automatic cooking device 40 thereof such that the dish is served to the user who has ordered the dish. When the dish is served by manpower, the restaurant staff is enabled to serve the dish by visually observing the position of the dish image 300 on the table 3. When the dish is served by a serving robot, the robot can be controlled to move to the vicinity of the seat of the user who has ordered the dish.

4-4. Change Operation after Ordering

The present embodiment enables display of cooking progress information on the table 3 to notify the user of the time required until the dish is served. When the order can be changed during cooking even after ordering, such as a change in seasoning, the present embodiment also enables notification of the details to the user to meet the user's request as much as possible even when the user's request has changed after ordering.

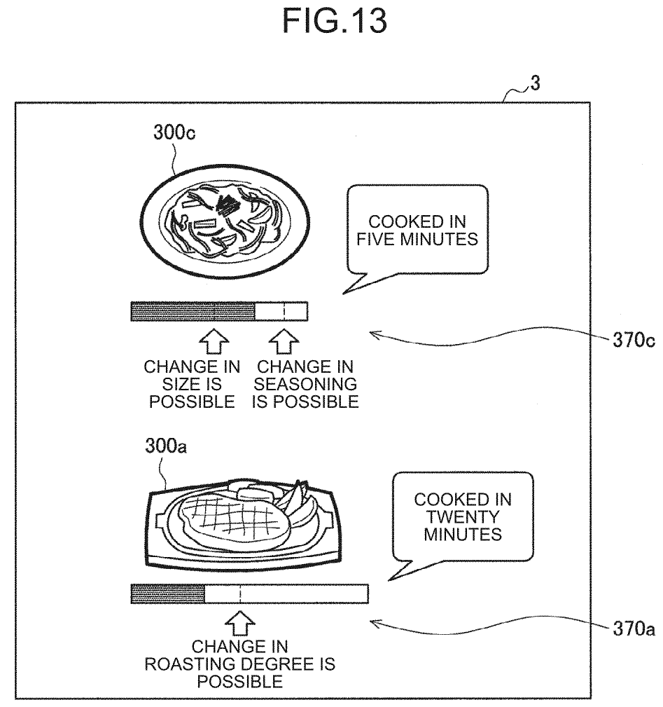

FIG. 13 is a diagram illustrating an example of the case of displaying cooking progress information on the table 3 according to the present embodiment.

As illustrated in FIG. 13, after the dishes are ordered, the ordered dish images 300 and cooking progress information 370 are displayed on the table 3. The cooking progress information 370 is updated in real time with the information processing apparatus 10 on the basis of the latest cooking information acquired from the automatic cooking device 40.

The cooking progress information 370 indicates progress of cooking, for example, with a bar graph or a circle graph. Such a bar graph or a circle graph indicates the timing until which the order contents can be changed. Specifically, for example, as illustrated in FIG. 13, the progress bar displays time limits until which the order contents can be changed, such as “change in size (quantity) is possible”, “change in seasoning is possible”, “change in roasting degree is possible”, and “canceling the order is possible”. The time limits are determined according to the process of cooking of the dish. The user is enabled to change the order with reference to the cooking progress information 370 even when the user's request has changed after ordering. When the information processing apparatus 10 detects order change, the information processing apparatus 10 notifies the automatic cooking device 40 of the change contents.

As described above, displaying the progress state of each of the dishes in real time enables the user to recognize the time required until the dish ordered by the user is served, and change the order contents even after ordering when the degree of progress does not reach a certain degree.

As explained above, in the present embodiment, the dish image 300 in the actual size in the actually served state and the additional information 330 are displayed on the table 3 at the time of ordering, an intuitive operation input performed by the user is reflected in real time on the dish image 300 and the additional information 330, to enable the user to input the order contents. This structure enables the user to intuitively and easily perform operation input even when the order is detailed, while checking whether the user is ordering the dish faithful to the user's request. In addition, displaying the state of the dish to be served with an image in advance solves a gap between the user's assumption and the actually served dish.

### 5. MODIFICATIONS

5-1. Sound Input

The example explained above illustrates the case of mainly using a touch operation as an operating method for inputting an order, but the present embodiment is not limited thereto. An order may be input by sound input using a microphone. For example, sound recognition may be used to perform menu selection (such as “three plates of salad, a pizza, and two plates of pasta”), adjustment of the quantity (such as “a little more quantity”), and equal dividing (such as “divide into X parts”). When the information processing apparatus 10 recognizes the user's voice collected with the microphone (an example of the input device 20) and acquires the order contents, the information processing apparatus 10 reflects the order contents in real time on the dish images and additional information displayed on the table 3, in the same manner as the case of using a touch operation.

In addition, in the present system, switching to sound input may be automatically performed on the basis of the user's state. For example, when the information processing apparatus 10 determines that the user is in a state of having difficulty in performing a touch operation, such as when the user holds one's child in one's arms and the user's hands are occupied, the information processing apparatus 10 may notify the user that sound input is possible and receive sound input.

In addition, when the present system is used at home, when the system senses that the user has moved away from the table 3 after ordering, the information processing apparatus 10 switches the input mode to sound input to enable reception of a user's instruction, such as change after ordering, by sound input even from a remote place.

The order input method is not limited to a touch operation for the dish images and/or additional information displayed on the table 3, but an order may be input by a hand gesture and/or movement of the head and/or the line of sight or the like. In any cases, when the information processing apparatus 10 recognizes the order contents placed by the user, the information processing apparatus 10 reflects the order contents in real time on the dish images and/or additional information displayed on the table 3.

As another example, when the order input method is switched to sound input, the information processing apparatus 10 may properly switch the UI (in FIG. 8 and the like) to change additional information on the dish, such as seasoning and roasting degree, to a sound input UI.

The information processing apparatus 10 may receive both a touch operation and sound input. This structure enables the user to, for example, designate the seasoning and the like by sound input while changing the size of the dish by a touch operation.

5-2. Modification of Display Output

The example described above illustrates the case of mainly displaying (projecting) the dish images 300 and the like on the table 3 on which the dishes are served, but the present embodiment is not limited thereto. For example, when the display area on the table 3 is not sufficient or the display area is difficult to look from a distant seat, another ambient display area may be used, such as a wall display.

The present system may also have a function of presenting the dish images and the like to be displayed on the table 3 and the like with a stereoscopic image.

As described above, the output device 30 of the present system may be a wearable device, such as a head mounted display (HMD) and augmented reality (AR) glasses. In this case, the information processing apparatus 10 or the output device 30 controls display such that in which the dish image 300 and the like appear to be positioned on the table in a transmission or non-transmission type display unit of the HMD or the AR glasses.

5-3. Others

Recommendation Based on User Information or the Like

When the information processing apparatus 10 receives an order, the information processing apparatus 10 may acquire user information (such as the eating history, the consumed calories, whether the user is on a diet, the health state, life habits, exercise habits, and the schedule), and present a proper menu (dish names) in view of the nutritive balance, the salt content, and the consumed calories, or present proper seasoning and/or quantity. As another example, the information processing apparatus 10 may issue a warning (such as “You are overeating”) on the basis of the user information.

For example, when the present system is used at home, the system may check the subsequent schedule of the user, and present a menu that can be quickly cooked as recommendation, when the user is scheduled to go out. In addition, when the present system is used at home, the system may present suitable dishes with respect to the nutritive balance (such as the quantity, the seasoning, and a change in ingredients to be used) as recommendation on the basis of the remaining quantity of foods in the refrigerator and/or the contents of the meal that user had on the day.

When the present system is used for serving of foods and drinks in a scene in which the customer's staying time is limited, such as an airport lounge, a bus terminal, and a train station, the information processing apparatus 10 may acquire the customer's schedule, the departure time, and/or the boarding time, and recommend dishes that can be served in the limited time. In addition, when spare time is still left after the meal is finished, the system may recommend coffee and the like after the meal.

The information processing apparatus 10 may also estimate attribute information, such as the age, the sexuality, and the number of users, from the user's appearance imaged with the camera 20a, and present a menu of proper quantity and/or seasoning as recommendation.

The information processing apparatus 10 may recognize the dishes placed on the table 3 with the camera 20a (or on the basis of the order contents), and present dishes and/or drinks matching the ordered dishes as recommendation.

The details of the recommendation described above are presented with dish images in the actual size assuming the actual serving state, and enables the user to visually recognize the details of the recommendation.

Mechanism for Reproducing Flavor and Taste

The present system is provided with a mechanism for reproducing the flavor and/or taste, as well as proposing the dish image in the actual size assuming the actual serving state. The mechanism solves a gap between the user's assumption and the actually served dish by proposing the flavor and/or the taste of the dish to be served to the user in advance.

Batch Request Input

The present system enables batch reflection of requests relating to NG ingredients caused by religion, the physical constitution (such as allergy and diseases), and preference and the like. For example, when a button “vegetarian” displayed on the table 3 is tapped, the whole menu is updated to a vegetarian menu.

Display of Temperature of Dish

The information processing apparatus 10 may sense hotness of the served dish, and display it (warning such as “Beware of burns on hot dishes!”) on the table 3.

Plate Clearing Function

A request to clear away the plate can be conveyed to the restaurant staff by an operation, such as tapping a space around the plate to be cleared away. Specifically, when the input device 20 detects a certain operation (gesture), such as tapping a space around the plate, the information processing apparatus 10 notifies the automatic cooking device 40 of a request to clear away the plate.

### 6. CONCLUSION

A preferred embodiment of the present disclosure has been explained in detail with reference to attached drawings, but the present technique is not limited to such an example. It is obvious that a person having ordinary skill in the technical field of the present disclosure could conceive various modifications or revisions within the range of the technical idea described in the claims, and these are regarded as also belonging to the technical range of the present disclosure as a matter of course.

For example, it is possible to generate a computer program to cause hardware, such as a CPU, a ROM, and a RAM, included in the information processing apparatus 10, the input device 20, the output device 30, or the automatic cooking device 40 to exhibit the functions of the information processing apparatus 10, the input device 20, the output device 30, or the automatic cooking device 40. In addition, a computer-readable storage medium storing the computer program therein is also provided.

The effects described in the present specification are explanatory or exemplary ones, and not limited thereto. Specifically, the technique according to the present disclosure can produce other effects obvious to the skilled person from the description in the present specification together with the effects described above, or instead of the effects described above.

The present technique can adopt the following structures.

(1) An information processing apparatus comprising

a controller performing:

control to display an interface receiving order contents relating to a dish from a user;

control to reflect a change in order contents based on an operation performed by the user in real time on a dish image included in the interface; and

control to transmit determined order contents to an external device.

(2) The information processing apparatus according to (1), wherein the controller performs control to display the dish image in actual size in a display area.
(3) The information processing apparatus according to (1) or (2), wherein the controller performs

control to display additional information including information relating to the dish indicated with the dish image, together with the dish image, and

control to reflect a change in order contents based on an operation performed by the user in real time also on the additional information.

(4) The information processing apparatus according to (3), wherein display of the additional information includes display of calories, price, nutritive values, volume, or serving time of the dish.
(5) The information processing apparatus according to (3) or (4), wherein the controller acquires information relating to cooking from an external device and generates the dish image and the additional information.
(6) The information processing apparatus according to any one of (1) to (5), wherein the controller detects a touch operation input performed by the user to the interface on the basis of sensing data and acquires the order contents.
(7) The information processing apparatus according to (6), wherein the controller performs control to change size of the dish image in accordance with a pinch-in operation or a pinch-out operation for the dish image and receive an order relating to the size of the dish indicated with the dish image.
(8) The information processing apparatus according to (6), wherein the controller performs

control to display adjustment display to change the order contents relating to seasoning, quantity, roasting degree, boiling degree, hardness, or used ingredients of the dish indicated with the dish image, and

control to receive a change in the order contents on the basis of a detection result for the touch operation performed by the user on the adjustment display.

(9) The information processing apparatus according to any one of (1) to (5), wherein the controller detects a sound input operation performed by the user on the interface on the basis of sensing data, and acquires the order contents.
(10) The information processing apparatus according to any one of (1) to (9), wherein, when number of pieces in the dish placed on a plate in the dish image is increased in accordance with an operation performed by the user on the interface, the controller generates a dish image in which the number of pieces is increased to a number being a multiple of number of the users.
(11) The information processing apparatus according to any one of (1) to (10), wherein, when an individual serving order is received for the dish placed on a plate in the dish image in accordance with an operation performed by the user on the interface, the controller generates a dish image in a state in which the dish is individually served in parts of a number being number of users.
(12) The information processing apparatus according to any one of (1) to (11), wherein, the controller recognizes a cutting part of the dish on the basis of a line traced by the user on the dish image by a touch operation and generates a dish image in a state of being cut at the cutting part.
(13) The information processing apparatus according to any one of (1) to (12), wherein the controller performs

control to present serving order of ordered dishes by arranging dish images thereof in time series, and

control to receive a change in the serving order in accordance with an operation input performed by the user on display in which the dish images are arranged in time series.

(14) The information processing apparatus according to any one of (1) to (13), wherein the controller performs control to display dish images of ordered dishes in actual size on a table on which the dishes are to be served, and receive designation of serving positions of the dishes.
(15) The information processing apparatus according to any one of (1) to (14), wherein the controller performs control to display cooking progress information on each dish included in the determined order contents, and clearly indicate changeable order contents and a time limit for each dish.
(16) The information processing apparatus according to any one of (1) to (15), wherein the controller outputs dish recommendation information on the basis of information on the user.
(17) The information processing apparatus according to (16), wherein the information on the user includes eating history, consumed calories, whether the user is on a diet, health state, life habits, exercise habits, and schedule of the user, or attribute information on the user estimated from a captured image acquired by imaging the user.
(18) An information processing method comprising causing a processor to:

display an interface receiving order contents relating to a dish from a user;

reflect a change in order contents based on an operation performed by the user in real time on a dish image included in the interface; and

transmit determined order contents to an external device.

(19) A computer program causing a computer to function as a controller performing:

control to display an interface receiving order contents relating to a dish from a user;

control to reflect a change in order contents based on an operation performed by the user in real time on a dish image included in the interface; and

control to transmit determined order contents to an external device.

### REFERENCE SIGNS LIST

1 COOING SYSTEM
3 TABLE
10 INFORMATION PROCESSING APPARATUS
100 CONTROLLER
101 DISPLAY CONTROLLER
102 OPERATION DETECTOR
103 ORDER PROCESSOR
110 COMMUNICATION UNIT
120 STORAGE UNIT
20 INPUT DEVICE
20a CAMERA
30 OUTPUT DEVICE
30a PROJECTOR
40 AUTOMATIC COOKING DEVICE
42 COOKING INFORMATION DB
300 DISH IMAGE

1. An information processing apparatus comprising
a controller performing:
control to display an interface receiving order contents relating to a dish from a user;
control to reflect a change in order contents based on an operation performed by the user in real time on a dish image included in the interface; and
control to transmit determined order contents to an external device.

2. The information processing apparatus according to claim 1, wherein the controller performs control to display the dish image in actual size in a display area.

3. The information processing apparatus according to claim 1, wherein the controller performs
control to display additional information including information relating to the dish indicated with the dish image, together with the dish image, and
control to reflect a change in order contents based on an operation performed by the user in real time also on the additional information.

4. The information processing apparatus according to claim 3, wherein display of the additional information includes display of calories, price, nutritive values, volume, or serving time of the dish.

5. The information processing apparatus according to claim 3, wherein the controller acquires information relating to cooking from an external device and generates the dish image and the additional information.

6. The information processing apparatus according to claim 1, wherein the controller detects a touch operation input performed by the user to the interface on the basis of sensing data and acquires the order contents.

7. The information processing apparatus according to claim 6, wherein the controller performs control to change size of the dish image in accordance with a pinch-in operation or a pinch-out operation for the dish image and receive an order relating to the size of the dish indicated with the dish image.

8. The information processing apparatus according to claim 6, wherein the controller performs
control to display adjustment display to change the order contents relating to seasoning, quantity, roasting degree, boiling degree, hardness, or used ingredients of the dish indicated with the dish image, and
control to receive a change in the order contents on the basis of a detection result for the touch operation performed by the user on the adjustment display.

9. The information processing apparatus according to claim 1, wherein the controller detects a sound input operation performed by the user on the interface on the basis of sensing data, and acquires the order contents.

10. The information processing apparatus according to claim 1, wherein, when number of pieces in the dish placed on a plate in the dish image is increased in accordance with an operation performed by the user on the interface, the controller generates a dish image in which the number of pieces is increased to a number being a multiple of number of the users.

11. The information processing apparatus according to claim 1, wherein, when an individual serving order is received for the dish placed on a plate in the dish image in accordance with an operation performed by the user on the interface, the controller generates a dish image in a state in which the dish is individually served in parts of a number being number of users.

12. The information processing apparatus according to claim 1, wherein, the controller recognizes a cutting part of the dish on the basis of a line traced by the user on the dish image by a touch operation and generates a dish image in a state of being cut at the cutting part.

13. The information processing apparatus according to claim 1, wherein the controller performs
control to present serving order of ordered dishes by arranging dish images thereof in time series, and
control to receive a change in the serving order in accordance with an operation input performed by the user on display in which the dish images are arranged in time series.

14. The information processing apparatus according to claim 1, wherein the controller performs control to display dish images of ordered dishes in actual size on a table on which the dishes are to be served, and receive designation of serving positions of the dishes.

15. The information processing apparatus according to claim 1, wherein the controller performs control to display cooking progress information on each dish included in the determined order contents, and clearly indicate changeable order contents and a time limit for each dish.

16. The information processing apparatus according to claim 1, wherein the controller outputs dish recommendation information on the basis of information on the user.

17. The information processing apparatus according to claim 16, wherein the information on the user includes eating history, consumed calories, whether the user is on a diet, health state, life habits, exercise habits, and schedule of the user, or attribute information on the user estimated from a captured image acquired by imaging the user.

18. An information processing method comprising causing a processor to:
display an interface receiving order contents relating to a dish from a user;
reflect a change in order contents based on an operation performed by the user in real time on a dish image included in the interface; and
transmit determined order contents to an external device.

19. A computer program causing a computer to function as a controller performing:
control to display an interface receiving order contents relating to a dish from a user;
control to reflect a change in order contents based on an operation performed by the user in real time on a dish image included in the interface; and
control to transmit determined order contents to an external device.
